(19) United States
(12) Patent Application Publication
(10) Pub. No.: US 2025/0338061 A1
(43) Pub. Date: Oct. 30, 2025

(54) MODULAR APPARATUS FOR CUSTOMIZING THE REDISTRIBUTION OF ACOUSTIC ENERGY

(71) Applicant: Harman Becker Automotive Systems GmbH, Karlsbad (DE)

(72) Inventors: Martin Olsen, Struer (DK); Karl Elias Nøhr Rittig, Holstebro (DK)

(73) Assignee: Harman Becker Automotive Systems GmbH, Karlsbad (DE)

(21) Appl. No.: 19/179,288

(22) Filed: Apr. 15, 2025

Related U.S. Application Data
(60) Provisional application No. 63/640,662, filed on Apr. 30, 2024.

(51) Int. Cl. H04R 1/34

(52) U.S. Cl. CPC H04R 1/345

(57) ABSTRACT

A modular apparatus of a sound system for distributing sound in a listening environment having a base component having a top surface, a bottom surface, a front surface having a fixed contoured shape, and an opening in the front surface. A loudspeaker driver component is positioned at the opening, and an insert component is attached to the front surface of the base component. The insert component has a topography that is customizable and interchangeable to shape and direct the redistribution of acoustic energy.

### CROSS-REFERENCE TO RELATED APPLICATIONS

This application claims the benefit of U.S. Provisional Application Ser. No. 63/640,662, MODULAR APPRATUS FOR CUSTOMIZING THE REDISTRIBUTION OF ACOUSTIC ENERGY, filed Apr. 30, 2024, the disclosure of which is incorporated in its entirety by reference.

### TECHNICAL FIELD

The inventive subject matter relates to an apparatus for redistributing acoustic energy, and more particularly to a modular apparatus for redistributing acoustic energy, such as an acoustic lens technology (ALT), which is configured to receive and distribute acoustic energy, such as sound.

### BACKGROUND OF THE INVENTION

Sound systems in a listening environment, and particularly an automotive vehicle listening environment, may have different tonal balance in different listening positions due to the directivity characteristics of loudspeakers. Acoustic energy, such as sound, radiating into the surrounding ambient space within the listening environment may result in different tonal balance characteristics and spatial robustness depending on the relative position of the listener to the loudspeaker, the loudspeaker position within the listening environment, and boundaries of the listening environment. Many other factors also add to the complexity of the sound system performance. For example, the number and placement of loudspeakers, the shape, and materials in the listening environment, such as materials used in a vehicle cabin for example, may affect how sound waves reflect off surfaces, exterior noises, and vibrations.

Spatial audio, or the ability to produce sounds within a three-dimensional space, makes a listener perceive audio as if it were part of their three-dimensional environment. A typical loudspeaker is limited in that it does not convey a sense of direction and distance. Further, a typical loudspeaker may have a low directivity at low frequencies. The loudspeaker's response may have increased directivity and/or peak/dips in the frequency response at higher frequencies caused by interference with local device geometrical features and/or the acoustical environment. Accordingly, the loudspeaker will not provide the same frequency response or tonal quality for each listener depending upon the listener's relative position to the loudspeaker. The response difference may result in reduced high frequency content perceived at some listening positions. Additionally, the response at angles away from a primary axis of the loudspeaker may have a distinctive character from the response on the primary axis. Typically, the distinctive character of the off-axis performance cannot be corrected electronically.

In a particular example, vehicle manufacturers offer many vehicle makes, models, trim level option packages, etc. that require customized sound systems that can add cost and complexity to vehicles. In another example, a multimedia system in a home will have an endless difference in materials, furniture placement, room size, etc. There is a need for an easily customizable redistribution of acoustic energy in a listening environment.

The current acoustic lens solution is a static component, in shape and functionality, hence modifying the existing primary geometrical features (hat, wings, cave, faceplate etc.) does not provide an option to realize specific acoustical targets such as multi-lobe directivity, asymmetric adjustment of the sound dispersion characteristics according to the local acoustical environment, and accommodating novel industrial design features without significantly compromising the resulting acoustical performance and hence reducing the sound quality potential.

### SUMMARY OF THE INVENTION

A modular apparatus of a sound system for distributing sound in a listening environment having a base component having a top surface, a bottom surface, a front surface having a fixed contoured shape, and an opening in the front surface. A loudspeaker driver component is positioned at the opening, and an insert component is attached to the front surface of the base component. The insert component has a topography that is customizable and interchangeable to shape and direct the redistribution of acoustic energy.

The modular apparatus wherein the insert component has a topology that is configured to satisfy a first predetermined target directivity.

The modular apparatus wherein the insert further comprises fastening features for attaching to the front surface of the base component so that it may be interchanged with an insert component having a topology that is configured to satisfy a second predetermined target directivity.

The modular apparatus wherein the insert component has a topology that is configured to redistribute acoustic energy in a wide beamwidth and a single main lobe focused towards a center of the listening environment.

The modular apparatus wherein the insert component has a topology that is configured to redistribute acoustic energy in a plurality of lobes wherein each main lobe of the plurality of lobes is focusing toward a distinct listening position in the listening environment.

The modular apparatus wherein the listening environment is a vehicle cabin, the plurality of lobes is a dual-lobe configuration, a first main lobe is focused toward a first listening position in a front portion of the vehicle cabin and a second main lobe is focused toward a second listening position in the front portion of the vehicle cabin.

The modular apparatus wherein the listening environment is a vehicle cabin, the plurality of lobes is a triple-lobe configuration, a first main lobe is focused toward a first listening position in a front portion of the vehicle cabin, a second main lobe is focused toward a second listening position in the front portion of the vehicle cabin, and a third main lobe is focused to a third listening position in a rear portion of the vehicle cabin.

A method for redistributing acoustic energy in a listening environment is carried out by positioning a loudspeaker driver in an opening of a fixed front surface of a base component,. The loudspeaker driver reproduces acoustic energy to be distributed into the listening environment. A first target directivity for redistributing the acoustic energy being reproduced by the loudspeaker component is defined. A topology of an insert component based on the first target directivity is customized. The insert component is attached to the fixed front surface of a base component wherein the acoustic energy is redistributed into the listening environment according to the first target directivity.

The method also defines a second target directivity for redistributing the acoustic energy being reproduced by the loudspeaker component. The topology of a replacement insert component is customized based on the second target directivity. And the insert component is replaced with the replacement insert component, wherein the acoustic energy is redistributed into the listening environment according to the second target directivity.

### BRIEF DESCRIPTION OF DRAWINGS

FIG. 1 is a perspective view of a modular apparatus;

FIG. 2 is an example of a predetermined target directivity for the modular apparatus;

FIG. 3 is an example of one or more embodiments of the modular apparatus in a listening environment;

FIG. 4 is an example of a predetermined target directivity for the base component;

FIG. 5A is an exploded perspective view of one or more embodiments of the modular apparatus;

FIG. 5B is a perspective view of one or more embodiments of the modular apparatus;

FIG. 6 is an example of one or more embodiments of the modular apparatus in a listening environment;

FIG. 7 is a perspective view of one or more embodiments of the modular apparatus;

FIG. 8 is an example of a predetermined target directivity for the base component; and

FIG. 9 is an example of one or more embodiments of the modular apparatus in a listening environment.

### DETAILED DESCRIPTION OF THE INVENTION

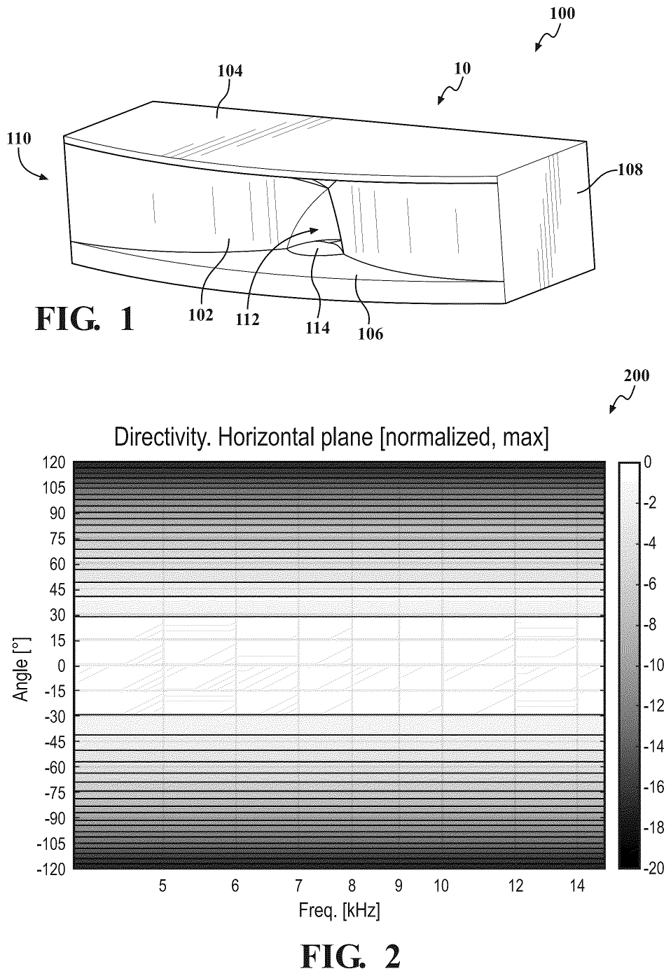

The inventive subject matter is a modular apparatus 10, or Acoustic Lens Technology (ALT), for customizing the redistribution of acoustic energy in a listening environment. FIG. 1 is a perspective view of a base component 100 of the modular apparatus 10. The base component 100 has a fixed front surface 102, a top surface 104, a bottom surface 106 and side surfaces 108, 110. The fixed front surface 103 has a fixed shape, any shape, but preferably contoured to meet the top surface 104, bottom surface 106, and side surfaces 108, 110. The contoured fixed shape is preferable to sharp edge transitions to avoid impinging sound on any surface transitions and/or negative interference of the sound.

In the example shown in FIG. 1, the fixed front surface 102, the top surface 104 and the side surfaces 108, 110 converge toward each other. The bottom surface 106 has an opening 112 that may be used for receiving the sound, or acoustic energy, to be redistributed. It should be noted that the example shown in FIG. 1 is only one of many configurations that are possible without departing from the scope of the invention.

In the example shown in FIG. 1, a loudspeaker driver component 114, i.e., a tweeter in the present example, is shown positioned in the opening in the bottom surface 106 of the base component 100. The loudspeaker driver component 114, such as the tweeter, is a driver designed to reproduce sound, wherein the modular apparatus 10 redistributes the sound reproduced at the tweeter. The fixed front surface 102 of the base component 100 is a primary component of the modular apparatus that itself is not altered and remains the same for any version of the modular apparatus installed in the listening environment.

It should be noted that the loudspeaker driver is not limited to the tweeter. In one or more embodiments, the base component 100 has a loudspeaker driver that is a full-range loudspeaker. For example, in one or more embodiments, the base component 100 has a loudspeaker driver that is a bullet tweeter. In one or more embodiments, the base component has a loudspeaker that is a passive radiator. In one or more embodiments, the base component has a loudspeaker driver that is an active component.

Furthermore, the base component 100 itself may consist of other structures. For example, in one or more embodiments, the base component is a tweeter horn. In one or more embodiments, the base component is a waveguide.

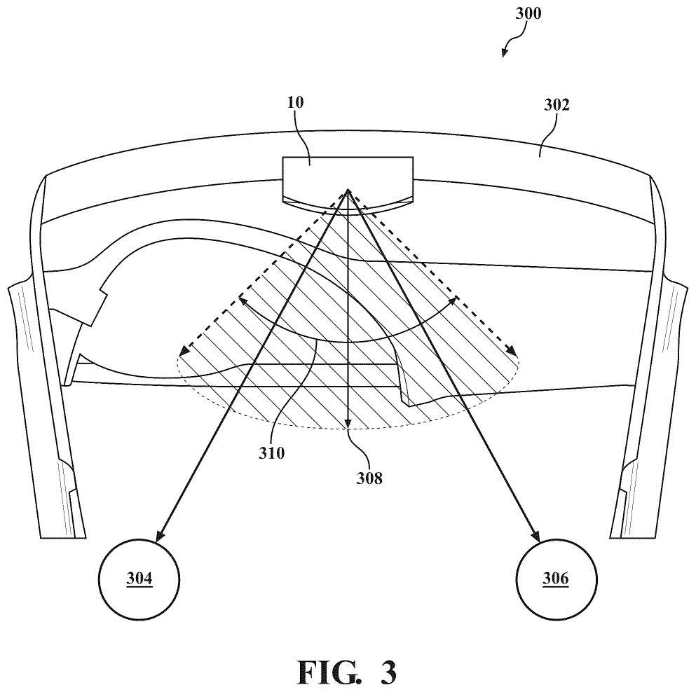

FIG. 2 is an example of a predetermined target directivity 200 for the modular apparatus 10 shown in FIG. 1. Without an insert component (to be described later herein), the base component 100 is an acoustic lens technology (ALT) that steers sound dispersion according to the predetermined target directivity 200. The predetermined target directivity 200 shown in FIG. 2 is a single-lobe, centered in a listening environment, with a wide bandwidth that is intended to cover multiple positions in the listening environment. FIG. 3 shows an example for a listening environment 300 that is a vehicle interior. The modular apparatus 10 is centered in a vehicle dashboard 302. Front right 304 and front left 306 listening positions, representative of a driver seat and a front passenger seat, are shown. The example of the base component 100 (shown with the loudspeaker driver component 114 that is the single tweeter) will direct, or redistribute, the acoustic energy with a main lobe path 308 that is focused on the center of the vehicle cabin, between the front right 304 and front left 306 listening positions. A wide beamwidth 310 encompassed both the front right and front left listening positions 304, 306.

The base component 100 of the modular apparatus 10 may (or may not) be modified by receiving a customizable insert (to be described in detail later herein) to realize the predetermined target directivity. In the example shown in FIGS. 1-3, the modular apparatus 10 does not have an insert component, whereby the geometry of the fixed front surface 102 alone is sufficient to achieve the predefined target directivity 200 that is desired within the listening environment 300 shown in FIG. 3.

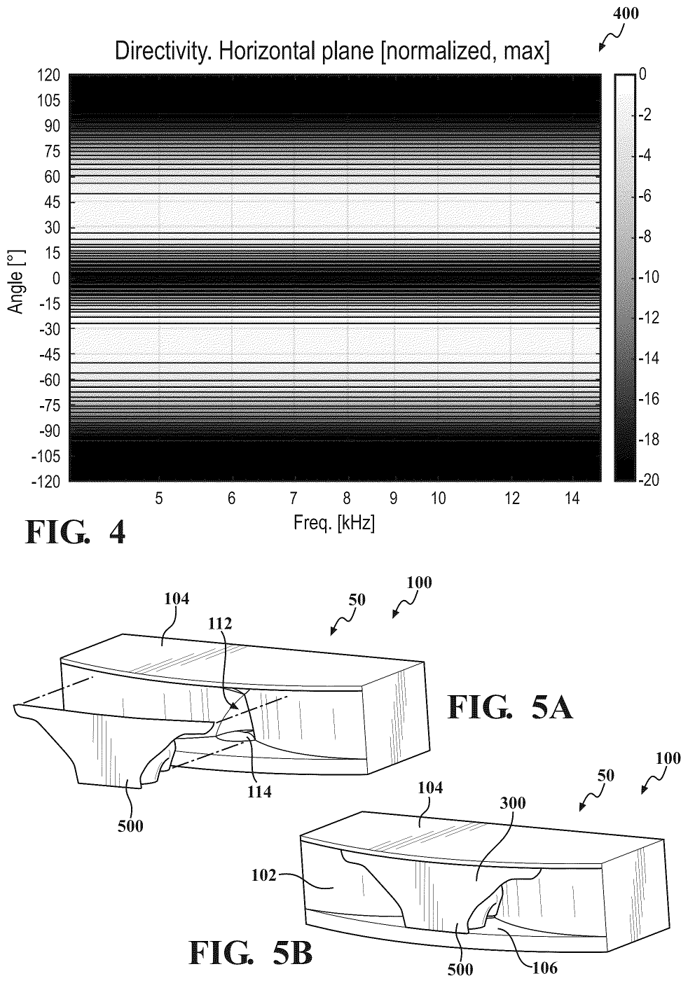

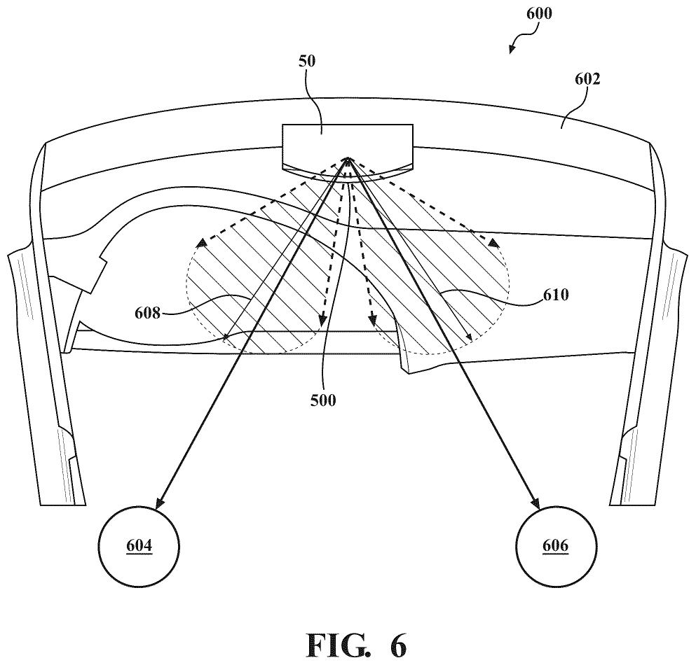

Referring now to FIGS. 4-6, one or more embodiments of the modular apparatus 50 inventive subject matter is shown. FIG. 4 is an example of a predefined target directivity 400 having a dual-lobe acoustic lens technology. In the predetermined target directivity 400 shown in FIG. 4, each main lobe of the dual-lobe is focused toward a listener in the listening environment (see FIG. 6). To accomplish the predetermined target directivity 400, the fixed front surface 102 of the base component 100 is modified by insertion of an insert component 500, thereby defining a modular apparatus 50 (see FIGS. 5A and 5B). The insert component 500 has a topology that, when inserted onto the fixed front surface 102 of the base component 100, adjusts the directivity of the sounds reproduced by the loudspeaker driver component 114 according to the predetermined target directivity 400.

FIGS. 5A and 5B show customization of the base component 100 into a modular apparatus 50 to redistribute acoustic energy according to the predetermined target directivity 400 of FIG. 4. This is accomplished by the addition of an interchangeable, customized insert component 500 that alters the functional characteristics of the base component 100 by scattering acoustic energy to modify a radiated sound field. For example, in FIG. 5A the base component 100 is shown with a loudspeaker driver component 114, similar to FIG. 3, and, in this exploded view, the insert component 500, in an example configuration, is to be inserted onto the fixed front surface 102 and, between the top surface 104 and the bottom surface 106 . . . . FIG. 5B is a perspective view with the insert component 500 in place.

The customizable insert component 500 is designed to accomplish the predefined target directivity 400, which in the present example, is the dual-lobe acoustic lens technology shown in FIG. 4. The outer dimensions of the insert component, or the dimensions of the features of the insert component that attach to the base component are standardized, or fixed so that any insert component may be interchangeable with any other insert component when it is swapped onto the base component 100. In other words, any insert component may be substituted for another insert component. However, surface features, such as contours, or other design features of the insert component that do not affect attachment to the base component, are determined in accordance with the acoustic design requirements or effects desired for the redistribution of acoustic energy within the listening environment. The possible configurations for surface features of the insert component are limitless.

FIG. 6 shows an example for a listening environment 600 that is a vehicle interior. The base component 100 is centered in a vehicle dashboard 602. Front right 604 and front left 606 listening positions, representative of a driver seat and a front passenger seat, are shown. The example of the modular apparatus 50, comprised of the base component 100 (shown with the loudspeaker driver component 114 that is the single tweeter) having the insert 500, redistributes the acoustic energy with a first main lobe path 608 that is focused on the front right 604 listening position and a second main lobe path 610 that is focused on the front left 606 listening position.

The functional characteristics of the base component 100 in the example shown in FIG. 2 are radically changed from the functional characteristics of the base component 100 having the insert 500 shown in FIGS. 5A and 5B. It should be noted that there are an infinite number of configurations for the surface and geometry of the insert 500. Through modification, or replacement, of the insert 500 the functional characteristics of the base component 100 may be customized, as desired, to meet the challenges of the physical listening environment, as well as individual listening positions.

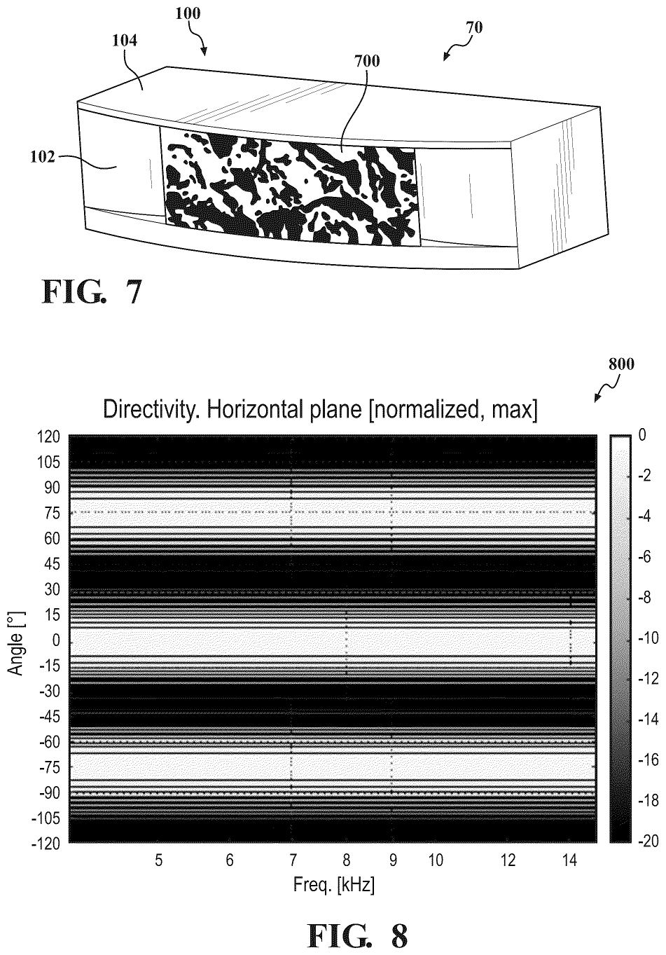

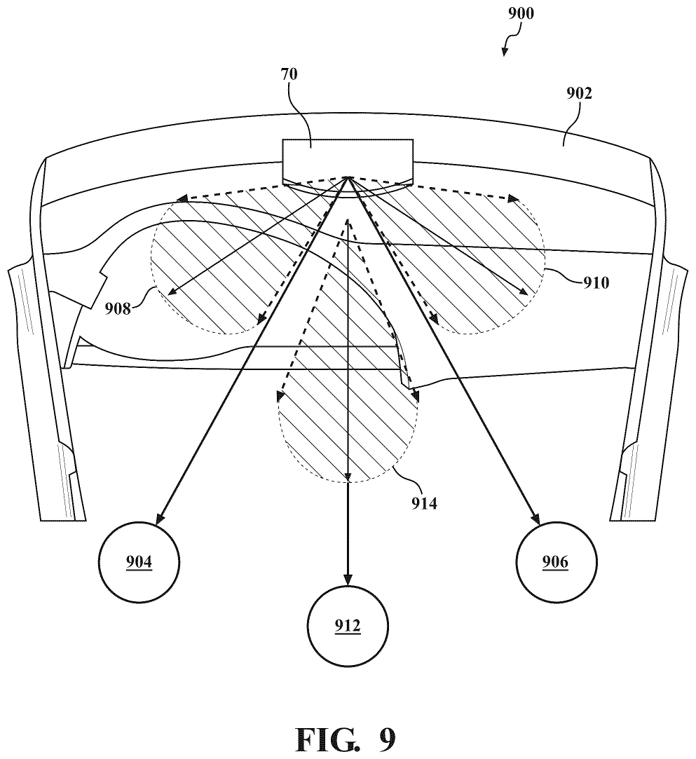

Referring now to FIGS. 7-9, one or more embodiments of the inventive subject matter is shown. FIG. 8 is an example of a predefined target directivity 800 having a triple-lobe acoustic lens technology. In the predetermined target directivity 800 shown in FIG. 8, each main lobe of the triple-lobe is focused toward a listener in the listening environment (see FIG. 9). To accomplish the predetermined target directivity 800, the fixed front surface 102 of the base component 100 is modified by insertion of an insert component 700, thereby defining a modular apparatus70. The insert component (shown in FIG. 7 adjusts the directivity of the sound reproduced by the loudspeaker driver component (not visible in FIG. 7).

FIG. 7 shows customization of the base component 100 into the modular apparatus 70 to redistribute acoustic energy according to the predetermined target directivity 800 of FIG. 8. This is accomplished by the addition of the customized insert component 700 that alters the functional characteristics of the base component 100 by scattering acoustic energy to modify a radiated sound field. The insert component 700, in an example configuration, is inserted onto the fixed front surface 102, between the top surface 104 and the bottom surface 106.

FIG. 9 shows an example for a listening environment 900 that is a vehicle interior. The modular apparatus 70 is centered in a vehicle dashboard 902. Front right 904, front left 906, and 912 center listening positions, representative of a driver seat, a front passenger seat, and a rear passenger seat are shown. The example of the modular apparatus 70, comprised of the base component 100, the loudspeaker driver component (not shown in FIG. 7), and the insert 700, redistributes the acoustic energy with a first main lobe path 908 that is focused on the front right 904 listening position, a second main lobe path 910 that is focused on the front left 906 listening position, and a third main lobe path 914 that is focused on the center listening position 912.

The customizable insert component 500, 700 may be designed using mathematical optimization and sound dispersion target(s) (such as horizontal, vertical, and/or full 3-D) that are to be realized by combining the existing base component and the customizable insert component. See FIGS. 2, 4, and 8 for example. The customizable insert component functions as an acoustic scatterer that modifies the radiated sound field from the base acoustic lens to satisfy the sound dispersion target. This target can be redefined or modified to reflect the in situ scenario (relative configuration of loudspeaker position, acoustical environment, primary listener position, and physical listening space such as automotive interior or domestic/venue).

In one or more embodiments, the styling or design of the modular apparatus 10, 50, 70 may be preserved, and the customizable insert component 500, 700 will redistribute the acoustic energy as desired, such as, for example, aligning performance of a left side or right side of the listening environment, realizing multiple beams, etc. without compromising the overall appearance of the modular apparatus 10, 50, 70 to a customer in the listening environment.

In one or more embodiments, the loudspeaker driver component 114 may be a tweeter horn or wave guide. In these embodiments, the customizable insert component 500, 700 would be designed and inserted into a horn throat, or outlet, to optimize acoustical output according to the predefined target directivity 200, 400, 800.

In one or more embodiments, the modular apparatus 10, 50, 70 may be packaged behind a grille assembly and/or integrated into a complex curved surface. For example, coupling surfaces of the modular apparatus 10, 50, 70 may connect the loudspeaker driver component 114 to a backside of the grille by way of the customizable insert component 500, 700.

In one or more embodiments, the insert 500, 700 may be accessed and replaced by the listener. For example, by way of snap-fit connectors, magnets, or simple screws that would allow the listener to remove an existing insert and replace it with a different insert, whereby the listener can modify the redistribution of acoustic energy to their preference.

The solution to cope with this is not trivial to even experienced acoustical engineers since passive control of broadband sound radiation-especially at high frequencies (e.g., 1.5-20 kHz)—relies on controlling broadband complex wave interaction. An advantage of the inventive subject matter is that acoustical performance can be maintained and/or modified according to the relative configuration of loudspeaker position, acoustical environment, primary listener position, and listening space, among other factors, by introducing the customizable insert component into a base component. Target and/or operational range frequency invariant behavior becomes possible because the resulting control is effective across the target frequency region. The solution disclosed here enables significant changes of the functional characteristics of the modular apparatus without altering the base component 100 (from mechanical and/or industrial design aspect) but by altering a design of the customizable insert component 500, 700, which is designed to be attached to the fixed front surface 102 of the base component 100, thereby making it easy to swap out. The same base component 100 may be installed in many different acoustical environments and different customizable inserts would account for the most prominent differences, making it possible to maintain acoustical performance metrics.

While exemplary embodiments are described above, it is not intended that these embodiments describe all possible forms of the inventive subject matter. Rather, the words used in the specification are words of description rather than limitation, and it is understood that various changes may be made without departing from the scope of the inventive subject matter. Additionally, features of various implementing embodiments may be combined to form further embodiments of the inventive subject matter.

1. A modular apparatus for customizing a redistribution of acoustic energy into a listening environment, the apparatus comprising:
a base component having a top surface, a bottom surface, a front surface having a fixed contoured shape, and an opening in the front surface;
a loudspeaker driver component positioned at the opening; and
an insert component attached to the front surface of the base component, the insert component has a topography that is customizable and interchangeable to shape and direct the redistribution of acoustic energy.

2. The modular apparatus as claimed in claim 1, wherein the insert component has a topology that is configured to satisfy a first predetermined target directivity.

3. The modular apparatus as claimed in claim 2, wherein the insert further comprises fastening features for attaching to the front surface of the base component so that it may be interchanged with an insert component having a topology that is configured to satisfy a second predetermined target directivity.

4. The modular apparatus as claimed in claim 1, wherein the insert component has a topology that is configured to redistribute acoustic energy in a wide beamwidth and a single main lobe focused towards a center of the listening environment.

5. The modular apparatus as claimed in claim 1, wherein the insert component has a topology that is configured to redistribute acoustic energy in a plurality of lobes wherein each main lobe of the plurality of lobes is focusing toward a distinct listening position in the listening environment.

6. The modular apparatus as claimed in claim 5, wherein the listening environment is a vehicle cabin, the plurality of lobes is a dual-lobe configuration, a first main lobe is focused toward a first listening position in a front portion of the vehicle cabin and a second main lobe is focused toward a second listening position in the front portion of the vehicle cabin.

7. The modular apparatus as claimed in claim 5, wherein the listening environment is a vehicle cabin, the plurality of lobes is a triple-lobe configuration, a first main lobe is focused toward a first listening position in a front portion of the vehicle cabin, a second main lobe is focused toward a second listening position in the front portion of the vehicle cabin, and a third main lobe is focused to a third listening position in a rear portion of the vehicle cabin.

8. A method for redistributing acoustic energy in a listening environment, the method comprising the steps of:
positioning a loudspeaker driver in an opening of a fixed front surface of a base component, the loudspeaker driver reproduces acoustic energy to be distributed into the listening environment;
defining a first target directivity for redistributing the acoustic energy being reproduced by the loudspeaker component;
customizing a topology of an insert component based on the first target directivity; and
attaching the insert component onto the fixed front surface of a base component;
wherein the acoustic energy is redistributed into the listening environment according to the first target directivity.

9. The method of claim 8, further comprising the steps of:
defining a second target directivity for redistributing the acoustic energy being reproduced by the loudspeaker component;
customizing a topology of a replacement insert component based on the second target directivity; and
replacing the insert component with the replacement insert component;
wherein the acoustic energy is redistributed into the listening environment according to the second target directivity.

10. The method of claim 8, wherein the step of defining a first target directivity further comprises defining a target directivity having at least one main lobe focused toward a listening position in the listening environment.

11. The method of claim 10, wherein the listening environment further comprises a plurality of listening positions, the step of defining a first target directivity further comprises defining a target directivity having a plurality of main lobes, and wherein each main lobe is focused toward a corresponding listening position in the plurality of listening positions.
